(19) United States
(12) Patent Application Publication
(10) Pub. No.: US 2025/0339852 A1
(43) Pub. Date: Nov. 6, 2025

(54) WEAK BASE ANION EXCHANGE RESIN PURIFICATION METHOD

(71) Applicant: ORGANO CORPORATION, Tokyo (JP)

(72) Inventors: Toshihiro NAKAMURA, Tokyo (JP); Haruo YOKOTA, Tokyo (JP); Koichiro HASHIMOTO, Tokyo (JP)

(73) Assignee: ORGANO CORPORATION, Tokyo (JP)

(21) Appl. No.: 18/879,071

(22) PCT Filed: May 24, 2023
(86) PCT No.: PCT/JP2023/019325

§ 371 Date: Dec. 26, 2024

(30) Foreign Application Priority Data
Jul. 1, 2022 (JP) 2022-107145

(51) Int. Cl. B01J 49/57; B01J 41/07; B01J 49/60

(52) U.S. Cl. CPC B01J 49/57; B01J 41/07; B01J 49/60

(57) ABSTRACT

Provided is a purification method capable of effectively reducing TOC components derived from weak base anion exchange resins. A method for purifying a weak base anion exchange resin is used, the method including: passing an acidic solution through the weak base anion exchange resin to make the resin in swollen state; washing the resin in swollen state with a washing water after the passing of the acidic solution through the weak base anion exchange resin; regenerating the resin with an alkaline aqueous solution after the washing of the resin in swollen state, wherein during the washing of the resin in swollen state, the washing water is passed through the resin in an amount of 4 or more times the amount of the resin.

### TECHNICAL FIELD

The present invention relates to a purification method capable of effectively reducing TOC components derived from weak base anion exchange resins used in pure water productions.

### BACKGROUND ART

Ion exchange resins are widely used in pure water productions. Among ion exchange resins, weak base anion exchange resins such as AMBERLITE™ IRA96SB and AMBERLITE™ HPR9700 are known for eluting a large amount of TOC, which affects the purity of pure water. Conventional methods for reducing TOC components in ion exchange resins are known to be effective for strong base anion exchange resins, including a purification method in which a reverse regeneration treatment with an acid and a treatment with an alkali are followed by a washing treatment with ultrapure water; washing with an organic solvent; and contacting with water or hot water (Patent Literature 1 and Patent Literature 2).

However, in the above-mentioned methods, when a weak base anion exchange resin is used, a large amount of TOC is eluted, and an effective method for reducing TOC has not yet been established.

### CITATION LIST

### Patent Literature

Patent Literature 1: JP 2002-102719 A
Patent Literature 2: JP 2014-036924 A

### SUMMARY OF INVENTION

### Technical Problem

Therefore, an object of the present invention is to provide a purification method capable of effectively reducing TOC components derived from weak base anion exchange resins.

### Solution to Problem

The present invention relates to a purification method for a weak base anion exchange resin, comprising: a reverse regeneration step of passing an acidic solution through the weak base anion exchange resin to make the resin in swollen state; a first washing step of washing the resin in swollen state with a washing water after the reverse regeneration step; a regeneration step of regenerating the resin with an alkaline aqueous solution after the first washing step, wherein in the first washing step, the washing water is passed through the resin in an amount of 4 or more times the amount of the resin.

### Advantageous Effects of Invention

According to the method of the present invention, TOC components derived from weak base anion exchange resins can be effectively reduced.

### BRIEF DESCRIPTION OF DRAWINGS

FIG. 1 is a graph showing the relationship between water passing time and ATOC of treated water in the examples and the comparative example.

### DESCRIPTION OF EMBODIMENTS

One embodiment of the present invention is a method for purifying a weak base anion exchange resin, in which the following reverse regeneration step, first washing step, and regeneration step are performed. First, in the reverse regeneration step, an acidic solution is passed through a weak base anion exchange resin to make the resin in swollen state. Next, in the first washing step, the resin in swollen state is washed with a washing water. In the regeneration step, the resin is regenerated with an alkaline aqueous solution. After the regeneration step, a second washing step may be carried out in which the weak base anion exchange resin is washed with a washing water.

In the reverse regeneration step, the weak base anion exchange resin is a synthetic resin in which functional groups (ion exchange groups) are introduced into a polymer matrix having a three-dimensional network structure. Examples of the polymer matrix of the ion exchange resin include styrene-divinylbenzene copolymers (styrene-based) and acrylic acid-divinylbenzene copolymers (acrylic-based). The weak base anion exchange resin may have any one of a gel type structure, a macroporous type structure, and a porous type structure. The functional groups of the weak base anion exchange resin are, for example, primary to tertiary amines. The weak base anion exchange resin is in the form of spherical particles, the harmonic mean particle size of which is, for example, 0.4 to 0.8 mm. The total exchange capacity of the weak base anion exchange resin is, for example, 1.0 to 2.5 meq/mL. Furthermore, the exchange groups of the weak base anion exchange resin are converted to HCl form in the reverse regeneration step.

In the reverse regeneration step, the pKa of the acidic solution passed through is less than 5 (pKa<5). If the pKa is less than 5, the weak base anion exchange resin can easily capture an acid in the acidic solution. The acidic solution is, for example, at least one selected from the group consisting of hydrochloric acid and sulfuric acid. The acidic solution may be a solution that has been made acidic by contact with a cation exchange resin (a solution that has passed through a packed tower filled with a cation exchange resin).

In the reverse regeneration step, the swollen state refers to a state in which the weak base anion exchange resin swells due to the passage of an acidic solution, and the rate of increase in volume of the weak base anion exchange resin before and after swelling is, for example, 5 to 40% when swollen with hydrochloric acid. The passing amount of hydrochloric acid as the acidic solution is preferably 0.5 to 5.0 eq/L resin, for example. The passing flow rate of the acidic solution is preferably, for example, SV 1.0 to 15 L/L resin/h for 5% hydrochloric acid, and SV 10 to 60 L/L resin/h for a solution that has become acidic by contact with a cation exchange resin.

In the first washing step, washing water is passed through the resin in an amount of at least four times the amount of the resin. Such an amount of liquid passed through the resin in the first washing step after the reverse regeneration step is considered to effectively reduce TOC components adhering to the pores of the resin while keeping the resin swollen and expanding the pores of the resin. The passing amount ratio of washing water relative to the resin is preferably 4 to 100 L/L resin. Since a large amount of water is consumed, in consideration of economic and environmental aspects, the passing amount ratio of water relative to the resin in washing is particularly preferable 4 to 50 L/L resin.

In the first washing step, the washing water is not particularly limited, but for example, pure water, particularly ultrapure water, can be used. The temperature of the washing water is not particularly limited, but may be, for example, 20° C. to 100° C., and preferably 40° C. to 70° C. By increasing the temperature of the washing water, the amount of eluted TOC components can be further reduced.

In the regeneration step, the alkaline aqueous solution is at least one selected from the group consisting of sodium hydroxide and potassium hydroxide. The concentration of the alkaline aqueous solution is preferably, for example, 0.1 to 4.0 eq/L. The passing amount of the solution is preferably 1.0 to 3.0 eq/L resin. The passing flow rate of the alkaline solution is preferably, for example, SV 1.0 to 15 L/L resin/h. The exchange groups of the weak base anion exchange resin are converted from HCl form to free base form during the regeneration step.

In the second washing step, the washing water is not particularly limited, but for example, pure water, particularly ultrapure water, can be used. The temperature of the washing water is not particularly limited, but may be, for example, 20° C. to 100° C., and preferably 40° C. to 70° C.

### EXAMPLES

The present invention will be described more specifically below with reference to examples and a comparative example. However, these examples and comparative example are merely illustrative for explaining the present invention, and the present invention is not limited to these examples and comparative example.

In the following examples and comparative example, the conditions were set so that the total amount of the washing water in the reverse regeneration step and the washing water in the regeneration step were the same. The column having φ26 mm was used, the resin used was weak base anion exchange resin HPR9700 (matrix: macroporous type, total exchange capacity: 1.25 meq/mL, harmonic mean diameter: 440-590 μm), and the resin amount was 300 mL. The TOC of the treated water was measured after 5 hours of passing the water using Sievers 5310C manufactured by Suez.

### Example 1

The reverse regeneration step, the first washing step, the regeneration step, and the second washing step were carried out under the following conditions. After the second washing step, a water passing test was carried out by supplying ultrapure water to the resin under the following conditions.

### Reverse Regeneration Step

Regeneration level: 2.4 eq/L resin

Concentration of passing liquid: 2% HCl (pKa<1)

Flow rate of passing liquid: SV=4 L/L resin/h

### First Washing Step

Flow rate of passing water: The following (1) to (3) were carried out in this order.

$$SV = 4 L / L resin / h \times 15 min \qquad ( 1 )$$

$$SV = 8 L / L resin / h \times 20 min \qquad ( 2 )$$

$$SV = 2.7 L / L resin / h \times 240 min \qquad ( 3 )$$

Amount ratio of passing water: 14.5 L/L resin

Temperature of washing water: Room temperature (20° C. to 25° C.)

### Regeneration Step

Regeneration level: 2.0 eq/L resin

Concentration of passing liquid: 4% NaOH

Flow rate of passing liquid: SV=4 L/L resin/h

### Second Washing Step

Flow rate of passing water: The following (1) to (3) were carried out in this order.

$$SV = 4 L / L resin / h \times 15 min , \qquad ( 1 )$$

$$SV = 8 L / L resin / h \times 30 min , \qquad ( 2 )$$

$$SV = 6 L / L resin / h \times 16 h \qquad ( 3 )$$

Amount ratio of passing water: 101 L/L resin

### Water Passing Test

Supply liquid: Ultrapure water

Flow rate of passing water: SV=50 L/L resin/h

### Example 2

The same procedures as in Example 1 were carried out except that the conditions for the first washing step after the reverse regeneration step and the conditions for the second washing step after the regeneration step were changed as follows.

### First Washing Step

Flow rate of passing water: The following (1) to (3) were carried out in this order.

$$SV = 4 L / L resin / h \times 15 min \qquad ( 1 )$$

$$SV = 8 L / L resin / h \times 20 min \qquad ( 2 )$$

$$SV = 2.7 L / L resin / h \times 33 min \qquad ( 3 )$$

Amount ratio of passing water: 5.2 L/L resin

### Second Washing Step

Flow rate of passing water: The following (1) to (3) were carried out in this order.

$$SV = 4 L / L resin / h \times 15 min , \qquad ( 1 )$$

$$SV = 8 L / L resin / h \times 30 min , \qquad ( 2 )$$

$$SV = 6 L / L resin / h \times 17.6 h \qquad ( 3 )$$

Amount ratio of passing water: 110.6 L/L resin

### Example 3

The same procedure as in Example 1 was carried out except that the conditions for the first washing step after the reverse regeneration step were changed as follows.

### First Washing Step

Temperature of washing water: 50-60° C.

### Example 4

The same procedure as in Example 1 was carried out except that the conditions for the first washing step after the reverse regeneration step were changed as follows.

### First Washing Step

Flow rate of passing water: (1) and (2) are the same as in Example 1. The following (3) and the temperature of washing water are different from those in Example 1.

$$SV = 2.7 L / L resin / h \times 240 min \qquad ( 3 )$$

Temperature of washing water: 75-85° C.

### Example 5

The same procedure as in Example 3 was carried out except that the conditions for the reverse regeneration step were changed as follows.

### Reverse Regeneration Step

Regeneration level: 2.4 eq/L resin

Concentration of passing liquid: 2.5% sulfuric acid (pKa<1)

Flow rate of passing liquid: SV=4 L/L resin/h

Temperature of washing water: 50-60° C.

### Comparative Example 1

The same procedures as in Example 1 were carried out except that the conditions for the first washing step after the reverse regeneration step and the conditions for the second washing step after the regeneration step were changed as follows.

### First Washing Step

Flow rate of passing water: The following (1) and (2) below are different from Example 1. (3) is the same as in Example 1.

$$SV = 4 L / L resin / h \times 15 min , \qquad ( 1 )$$

$$SV = 8 L / L resin / h \times 20 min , \qquad ( 2 )$$

which are carried in this order,

Amount ratio of passing wate: 3.7 L/L resin

### Second Washing Step

Flow rate of passing water: The following (1) to (3) were carried out in this order.

$$SV = 4 L / L resin / h \times 15 min , \qquad ( 1 )$$

$$SV = 8 L / L resin / h \times 3 min , \qquad ( 2 )$$

$$SV = 6 L / L resin / h \times 17.8 h \qquad ( 3 )$$

Amount ratio of passing water: 112 L/L resin

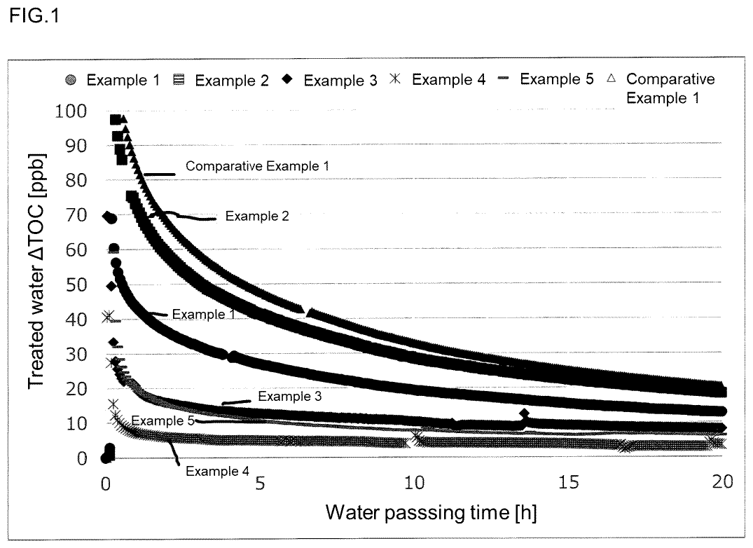

The results of the water passing test for the above-mentioned examples and comparative example are summarized in Table 1. FIG. 1 shows the relationship between water passing time and the TOC of treated water in the above examples and comparative example.

TABLE 1
Test results (Comparison of TOC values of treated
water after 5 hours of water passing)

| | Concentration |
|---|---|
| | (ppb) |
| Example 1 | 27 |
| Example 2 | 41 |
| Example 3 | 13 |
| Example 4 | 5 |
| Example 5 | 10 |
| Comparative | 47 |
| Example 1 | |

Comparing Comparative Example 1 and Examples 1-2, it was confirmed that the TOC components eluted from the resin were reduced by increasing the amount of water passed in the first washing step after the reverse regeneration step to four times or more the amount of the resin.

It was also confirmed that by increasing the temperature of the washing water in the first washing step after the reverse regeneration step to a high temperature such as 50° C. to 85° C. as in Examples 3 and 4, the eluted TOC components can be further reduced.

In addition, in Example 5, when the acid used in the reverse regeneration step was changed from hydrochloric acid to sulfuric acid, the same effect can be obtained as hydrochloric acid, and it is also possible to reduce the TOC components derived from the weak base anion exchange resin with acids other than hydrochloric acid.

As shown in FIG. 1, it was confirmed that, compared with Comparative Example 1, Examples 1 to 5 all rapidly reduced the eluted TOC even before 5 hours of water passing time.

1. A purification method for a weak base anion exchange resin, comprising:
passing an acidic solution through the weak base anion exchange resin to make the resin in swollen state;
washing the resin in swollen state with a washing water after the passing of the acidic solution through the weak base anion exchange resin;
regenerating the resin with an alkaline aqueous solution after the washing of the resin in swollen state,
wherein during the washing of the resin in swollen state, the washing water is passed through the resin in an amount of 4 or more times the amount of the resin.

2. The purification method according to claim 1, wherein during the passing of the acidic solution through the weak base anion exchange resin, the acidic solution has a pKa<5.

3. The purification method according to claim 1, wherein during the washing of the resin in swollen state, a temperature of the washing water is 20° C. to 100° C.

4. The purification method according to claim 1, wherein during the passing of the acidic solution through the weak base anion exchange resin, the acidic solution is at least one selected from the group consisting of hydrochloric acid and sulfuric acid.

5. The purification method according to claim 1, wherein during the regenerating of the resin with the alkaline aqueous solution, the alkaline aqueous solution is at least one selected from the group consisting of sodium hydroxide and potassium hydroxide.
